(19) United States
(12) Patent Application Publication
(10) Pub. No.: US 2007/0129065 A1
(43) Pub. Date: Jun. 7, 2007

(54) SYSTEM AND METHOD FOR PROVIDING ADVERTISING USING A COMMUNICATION NETWORK FOR MOBILE PHONES

(76) Inventors: Justin Divis, Huntington Beach, CA (US); Shane Leopard, Maricopa, AZ (US)

Correspondence Address: SCHMEISER OLSEN & WATTS, 18 E UNIVERSITY DRIVE, SUITE # 101, MESA, AZ, 85201, US

(21) Appl. No.: 11/566,592

(22) Filed: Dec. 4, 2006

Related U.S. Application Data
(60) Provisional application No. 60/742,735, filed on Dec. 5, 2005.
(60) Provisional application No. 60/746,006, filed on Apr. 28, 2006.

(51) Int. Cl. H04Q 7/22

(52) U.S. Cl. 455/414.1

(57) ABSTRACT

A communication network provides telephone communications between user and client phones. An audio signal is stored as an audio file that is accessible to the communication network. The audio signal is provided to the client phone in response to it being in a hold condition. The audio signal is determined in response to a parameter of the user or client phones.

### CROSS-REFERENCE TO RELATED APPLICATIONS

This application claims priority to U.S. Provisional Application Nos. 60/742,735 and 60/746,006, filed on Dec. 5, 2005 and Apr. 28, 2006, respectively, by the same inventor, the contents of both of which are incorporated herein by reference in their entirety.

### BACKGROUND OF THE INVENTION

1. Field of the Invention

This invention relates to electronic devices and, more particularly, to mobile phones.

2. Description of the Related Art

The use of personal hand held electronic devices, such as mobile phones, pagers, and personal digital assistants is very widespread. These electronic devices are designed to be conveniently carried by a user and are highly portable. The expense of owning a mobile phone is decreasing and they are replacing phones that communicate through land lines. To generate more revenue and attract more customers, the mobile phone industry provides a number of accessories to the mobile phone user.

Examples of mobile phone accessories include tones, which can be selectively downloaded by the user, and stored with his or her mobile phone. Tones generally include ring and ring back tones. A ring tone is what a user hears when someone calls his or her mobile phone. A ring back tone is what the caller hears when calling someone else's mobile phone. The ring and ring back tones generally include specialized rings and songs that play when a call is received. As of yet, however, there are no similar features available for when a person is holding.

### BRIEF SUMMARY OF THE INVENTION

The present invention employs a communication system that includes a client phone in communication with another phone through a communication network. An audio signal is provided to the client phone in response to it having a hold condition. The audio signal is not provided to the client phone when it does not have a hold condition. The audio signal is stored externally to the client phones at a location accessible to the communication network.

In one embodiment, the same audio signal is provided to all of the client phones that are holding. In another embodiment, the audio signal is selected from a number of audio signals. In some situations, the selected audio signal is determined in response to a parameter of the client phone and, in other situations, it is not. The parameter can be a phone number, area code, and the like. The selected audio signal can be an advertisement whose content is chosen, based on the parameter of the client phone, to appeal to the user of that particular client phone.

These and other features, aspects, and advantages of the present invention will become better understood with reference to the following drawings and description.

### BRIEF DESCRIPTION OF THE DRAWINGS

FIG. 1 is a flow chart of a method of providing an audio signal to a client phone, in accordance with the invention.

FIG. 2 is a perspective view of a base-station.

FIG. 3 is a flow chart of another method of providing an audio signal to a phone user, in accordance with the invention.

FIG. 4 is a block diagram of a communication system, in accordance with the invention, for providing an audio signal to a phone user.

FIG. 5 is a block diagram of another communication system, in accordance with the invention, for providing an audio signal to a phone user.

### DETAILED DESCRIPTION OF THE INVENTION

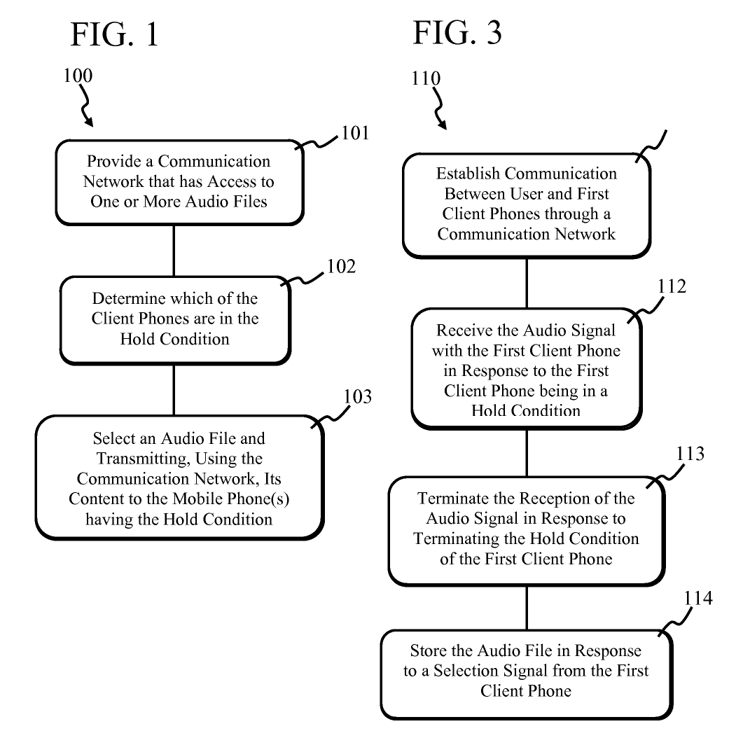

FIG. 1 is a flow chart of a method 100 of providing an audio signal to a client phone, in accordance with the invention. In this embodiment, method 100 includes a step 101 of providing a communication network that has access to one or more audio files. The communication network provides telephone communications between the client phones. There are several types of communication networks available and they can utilize many different telephone communication methods, such as code division multiple access (CDMA), time division multiple access (TDMA) and global system for mobile communication (GSM).

The communication network can communicate with many different types of client phones, such as wired and wireless phones. Wired phones transmit and receive signals through a phone line connected to it and wireless phones transmit and receive signals wirelessly and are often referred to as mobile and cellular phones.

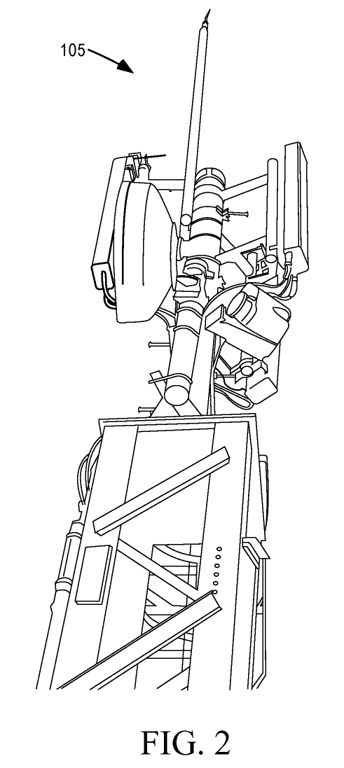

Communication systems that provide communication with wireless phones often include a base-station. A base-station is a two-way radio installation that flows communication signals between one or more phones, with at least one of them being a wireless phone. In this way, people can talk to each other using the phones. An example of a base-station is shown in FIG. 2. The base-station and mobile phones each include their own transceiver which is used to transmit and receive the communication signals. Base-stations can be controlled locally or remotely. Locally controlled base-stations often include a base-station cabinet with front panel controls that is used to control the operation of the base-station. Remotely controlled base-stations can be operated in a number of different ways, such as through control signals sent via wireless and land-line communication links.

Base-stations can include many different components. For example, a base-station typically includes an antenna in communication with electronic communication equipment. It also typically includes one or more transceivers for receiving and transmitting various signals, such as the communication signals mentioned above. Digital signal processors are often included to process the communication signals and control electronics are used to control the operation of the base-station. The control electronics can be a computer which operates software. The base-station components are often positioned on a tower so that the base-station can communicate over a larger distance with client phones.

In this embodiment, the communication network is generally in communication with one or more client phones and the client phones are in communication with each other through the communication network. The client phones can be of many different types, but here they are wireless phones. In other embodiments, the client phones can be wired phones or combinations of wired and wireless phones. The client phones can be made by many different manufacturers, several of which are known in the art. Examples of a few include Nokia, Verizon, Cingular, and the like.

The audio file can be of many different types, but it is generally a data file such as an MP3 file. These data files include information stored digitally so the information is readily accessible to a computer, such as a computer included with the base-station. The content of the data file corresponds to an audio signal S_{Audio}, which can be of many different types. However, audio signal S_{Audio} is generally one that can be transmitted by the communication network and received and played by the client phones.

The audio file can be stored in many different ways, but it is generally stored externally to the client phones so it is accessible to the communication network. For example, it can be stored with the base-station using one of the base-station components mentioned above, such as the computer. The base-station components can include internal and/or external memory, which can be used to store the audio file. There are many different types of external memory that can be used, such as memory sticks that include FLASH memory. The audio file is stored externally to the client phone because an audio file generally requires a large amount of memory, which is not available on most mobile phones.

The audio file can include many different types of information, such as a voice message, music, news, advertisements or any other audible information. The audio signal can also correspond to a radio station signal. In some embodiments, the client phone allows its user to record a message, which is used as audio signal S_{Audio}. The recordation of the message can be facilitated with the use of many different types of electronic devices, such as a computer, music player and/or a microphone. In this way, the user has the ability to create, download and upload his or her own personalized data file.

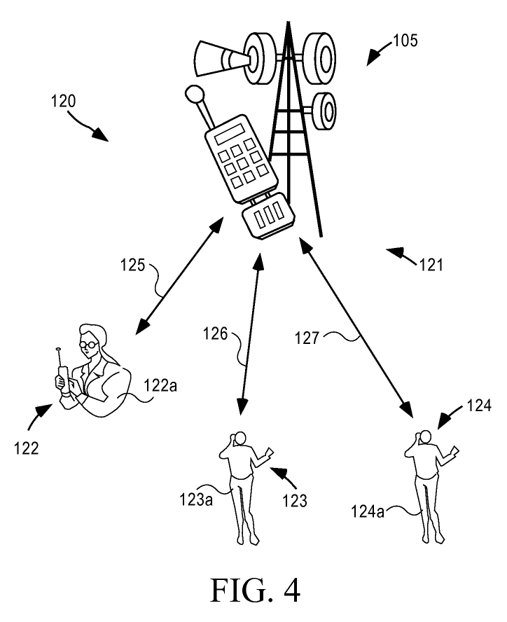

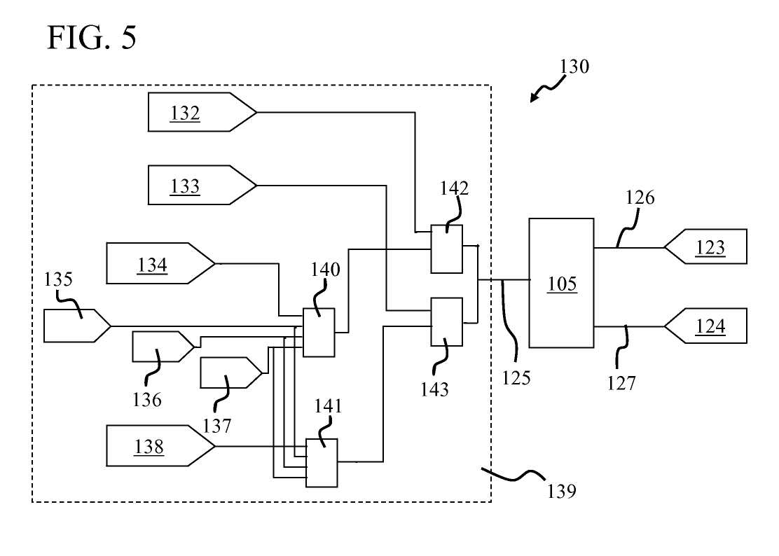

The audio files can be prestored or they can be uploaded and stored using the client phone. As discussed in more detail with FIG. 4, the audio files can be stored with a base-station and, as discussed in more detail with FIG. 5, the audio files can be stored with a phone. A number of prestored audio files can exist and one or more of them can be selected by the user of the client phone. In some situations, access to the stored audio files can be a paid feature and in other situations, it is a free feature. Advertisers can also pay to have their own audio file stored so the user of the client phone has the option of selecting it. Also, the user can purchase recordings, such as songs, for the purpose of having the option to use those purchased recordings as audio signal S_{Audio}.

The creation, downloading and uploading of the personalized audio file can be facilitated with the software mentioned above used to operate the computer of the base-station. For example, the user can upload audio files to the communication network through an internet connection established with the computer. The audio file can also be uploaded using his or her mobile phone. Hence, the computer software is used to allow the communication network to store, retrieve and transmit the audio signals. This can be the same software currently in use to implement the telephone communication method, such as CDMA, TDMA and GSM.

A client phone can have many different conditions of operation. For example, when it is turned on, it typically has active, inactive and hold conditions. In the active condition, a communication link is established between it and at least one other phone through the communication network. It should be noted that signals can flow through a communication link when it is established so people can talk to each other. In the inactive condition, a communication link is not established between the client phone and any other phones. Signals cannot flow through a communication link when it is not established so people cannot talk to each other. In some situations, the communication link is often one or more communication links connected together which allow signals to flow between the communication network and the client phones when the links are established. The number of communication links and how they are connected together is generally determined by the communication network.

In the hold condition, the communication link is established, but the ability to flow signals through it is restricted, which can be done in many different ways. For example, in one situation, a communication link between two client phones is established so they are both in their active conditions. The user of the first client phone then establishes the second client phone in the hold condition so the communication link between the first and second client phones is still established, but the flow of signals between them is restricted. In this way, the first and second client phones are still connected to the communication network, but not to each other.

The hold condition is useful when the first client phone has a communication link established with the second client phone, but receives an indication that it is receiving another call from another phone, such as a third client phone. The user of the first client phone can initiate the hold condition for the second client phone and establish a communication link with the third client phone. The user of the second client phone “holds” while the user of the first client phone communicates through the other communication link with the user of the third client phone.

Method 100 includes a step 102 of determining which of the client phones are in the hold condition. A client phone can be moved to the hold condition in many different ways. For example, its hold condition can be established in response to it receiving a hold signal S_{Hold}. Signal S_{Hold} can be provided from many different sources, such as the communication network and/or another client phone. The communication link with the holding client phone can then be reestablished so that it is in its active condition. In this way, a client phone is moved between active and hold conditions. It should be noted that in some situations, more than one client phone can have a hold condition.

The communication link between the client phone and another phone can also be terminated. The communication link can be terminated in many different ways, such as by providing it with a termination signal S_{Term}. Signal S_{Term} can be provided from many different sources, such as the communication network and/or another client phone.

In a step 103, an audio file is selected and its content is transmitted, using the communication network, to the client phone(s) having the hold condition. The content of the audio file is transmitted as audio signal S_{Signal}, which is a signal that includes information that is received by the client phone and converted to sound that is outputted by the client phone. In this way, the content of the audio file corresponding to audio signal S_{Signal} is played when the client phone is moved from an active condition to a hold condition. The playing of the content of audio signal S_{Audio} is terminated in response to terminating the hold condition of the client phone. In this way, the output of the audio file content is terminated in response to an indication that the hold condition of client phone 103 is terminated.

The audio file can be selected in many different ways. For example, in some situations, the audio file is selected so that the same one is transmitted to all the client phones having the hold condition. In other situations, the audio file is selected in response to a parameter of the client phone. The parameter of the client phone can correspond to many different types of information.

For example, the parameter can be the phone number of the client phone or the area code. This is useful so an audio file corresponding to a geographical region can be selected. This is also useful so that personal information corresponding to the user of the client phone can be used to select the audio file. The personal information can be obtained from the phone records of the user. The user of the client phone is generally its owner, although it can be somebody else in some situations. For example, the phone can belong to a company and the user can be an employee of the company. In another example, the phone can belong to an adult and the user can be a relative of the adult.

The personal information can be of many different parameters, such as age, birth date, sex, medical history, number of children and marital status, among others. For example, audio signal S_{Signal} can be selected in response to an age parameter from the phone records corresponding to the user. This is useful so an audio file corresponding to an advertisement appealing to a particular age group can be selected. If the age parameter from the personal information indicates that the owner of the client phone is a teenager, then the audio signal can be an advertisement that is likely to be appealing to teenagers. If the parameter from the personal information indicates that the owner of the client phone is a mother of an infant, then the audio signal can be an advertisement that is likely to be appealing to mothers having infants.

The parameter can correspond to a location indication, such as from a global positioning system. This is useful so an audio file corresponding to the geographical location of the user can be selected. The parameter can also correspond to the time (i.e. 7:30 am or 1:15 pm) at the location of the client phone. This is useful so an audio file corresponding to a particular time of day can be selected. For example, during morning hours, the selected audio file can include an advertisement for lunch at a restaurant. Further, during afternoon hours, the audio file can include an advertisement for dinner at a restaurant.

In some embodiments, the parameter corresponds to that of a business wherein the client phones are used by employees of the business. For example, the audio files can be customized to provide advertising or messages for this particular business. This is often the case in construction management or sales businesses, for example. Method 100 provides these businesses with the ability to create customized business hold messages on each of their employees' mobile phones. Method 100 also allows these businesses to play special messages or advertisements to customers on hold regardless of whether the employee is using their mobile phone or a land line.

The advertisement can be selected based on time zones too. This is useful to provide national coverage for a company having locations in different time zones. For example, a national chain restaurant can have an audio file corresponding to its advertisement played in the late afternoon in the Eastern, Central, Mountain and/or Pacific Time zones of the United States, to attract customers for dinner. The national chain restaurant can also have its audio file advertisement played in predetermined states and/or cities throughout these time zones.

In some embodiments, advertising time slots are sold to advertisers. The advertisers can be of many different types, such as individuals and businesses. The businesses can be of many different types, such as marketing firms that market products, political messages and/or services. Advertisers wanting to broadcast a particular hold advertisement can purchase the time slot from the mobile phone provider. Advertisers can purchase the time slot so that their advertisement is played for users on hold within a local and/or national wireless communication network. Advertising can also be done on a local, national or world wide level. Mobile phone providers also have the ability to partner with other mobile phone providers in order to allow advertisers to purchase advertising on multiple provides which and reach a larger audience.

Hence, an advantage of method 100 is that is allows a large number of mobile phone users to be exposed to advertisements when holding. This is useful so that advertising and/or marketing firms can expose a larger number of mobile phone users to advertisements and generate more revenue.

An advantage of the communication network of method 100 is that it is not necessary to modify the client phones it provides communications for, although they can be in some embodiments. Instead, the communication network is modified to give it access to the audio files. In this way, the operation of the communication network can be implemented using existing mobile phones. It should be noted that computer software is typically used to allow the communication network to store, retrieve and transmit the audio signals. This can be the same software currently in use to implement the telephone communication method, such as CDMA, TDMA and GSM.

FIG. 3 is a flow chart of a method 110 of providing an audio signal to a phone user, in accordance with the invention. In this embodiment, method 110 includes a step 111 of establishing communication between a user phone and a first client phone through a communication network. Method 110 also includes a step 112 of receiving the audio signal with the first client phone in response to the first client phone being in a hold condition. The hold condition of the first client phone can be established in many different ways, but here it is established in response to it receiving a hold signal. In accordance with the invention, the audio signal is determined in response to the parameter of the user and/or first client phones. The audio signal corresponds to an audio file accessible to the communication network.

It should also be noted that method 110 can include many other steps. For example, in some embodiments, method 110 includes a step 113 of terminating the reception of the audio signal in response to terminating the hold condition of the first client phone. The hold condition of the first client phone can be terminated in many different ways, but here it is terminated in response to it receiving a termination signal.

Method 110 can also include a step 114 of storing the audio file using the user phone. The audio file can be stored with many different locations, such as with the communication network, but it is generally stored externally with the user and first client phones. Further, method 110 can include establishing, through the communication network, communication between the user and first client phones and a second client phone, such as in a “conference call”. It should be noted that one or more client phones can be in the hold condition and provided with the same or different audio signals and the illustration of two client phones here is for simplicity.

The first and second client phones can receive and output the same or different audio signals when they are in the hold condition. This feature is useful because it allows the user of user phone 102 to select the audio signal played for the users of first and second client phones when they are in their hold conditions. This is another way in which the playing of the audio signals can be customized in response to the parameter of the client phone(s).

FIG. 4 is a block diagram of a system 120, in accordance with the invention. In this embodiment, system 120 includes a communication network 121, which generally includes a base-station 105 (FIG. 2), and provides telephone communications. In this embodiment, a user phone 122 and a client phone 123 are in communication with each other through communication links established with communication network 121. User phone 122 is being used by a user 122a and client phone 123 is being used by a user 123a. Here, user phone 122 is in communication with base station 105 with a communication link 125 and client phone 123 is in communication with base station 105 with a communication link 126. Base station 105 connects communication links 125 and 126 together so signals can flow between phones 122 and 123 and users 122a and 123a can talk to each other.

Phones 122 and 123 can be of many different types, but in this embodiment they are mobile phones. In other embodiments, phone 122 and/or phone 123 can be a wired phone. Phones 122 and 123 can be made by many different manufacturers, several of which are known in the art. Phones 122 and 123 can have many different conditions of operation, which were discussed in more detail above. For example, when phones 122 and 123 are turned on, they can have active, inactive and hold conditions.

Client phone 123 can be moved to its hold condition in many different ways. For example, its hold condition can be established in response to it receiving a hold signal S_{Hold}, which flows through communication link 126. Signal S_{Hold} can be provided from many different sources, such as communication network 121 and/or user phone 122. User phone 122 can then reestablish the communication link with client phone 123 so that client phone 123 is in its active condition. In this way, client phone 123 is moved between active and hold conditions.

User phone 122 can also terminate the communication link between it and client phone 123. The communication link can be terminated in many different ways. In one way, a termination signal S_{Term} is provided to client phone 123 through communication link 126. Signal S_{Term} can be provided from many different sources, such as communication network 121 and/or user phone 122.

In the hold condition, communication link 126 is established, but the ability to flow signals through it is restricted. The ability to flow signals can be restricted in many different ways. For example, in one situation, a communication link between phones 122 and 123 is established so that phone 123 is in its active condition. User 122a then establishes phone 123 in the hold condition so the communication link between phones 122 and 123 is still established, but the flow of signals between them is restricted. In this way, phones 122 and 123 are still connected to communication network 121, but not to each other.

The hold condition is useful when phone 122 has a communication link established with phone 123, but receives an indication that it has received another call from another phone, such as a client phone 124 being used by a user 124a. User 122a can initiate the hold condition for client phone 123 and establish a communication link 127 with client phone 124. User 123a “holds” while user 122a communicates through the other communication link with user 124a.

In accordance with the invention, audio signal S_{Audio} is provided to client phone 123 in response to it being in its hold condition. Audio signal S_{Audio} flows from communication network 121 to client phone 123 through communication link 126. In particular, audio signal S_{Audio} flows from base station 105 to client phone 123. Client phone 123 receives signal S_{Audio} and outputs it so that user 123a can hear it. In this way, the content of the audio file corresponding to audio signal S_{Signal} is played when client phone 123 is moved from an active condition to a hold condition. Further, audio signal S_{Audio} is terminated in response to terminating the hold condition of client phone 123. In this way, the output of the audio file content is terminated in response to an indication that the hold condition of client phone 123 is terminated.

Audio signal S_{Audio} can be of many different types, but it is generally one that can be transmitted by communication network 121 and received and played by client phone 123. Hence, audio signal S_{Audio} is generally a signal that can be flowed through the communication link(s) established by communication network 121. Further, signal S_{Audio} is generally one that can be stored so it is accessible by communication network 121. For example, audio signal S_{Audio} can be a data file, of which there are many different types known in the art, such as an MP3 file. These data files generally include information stored digitally.

As mentioned above with FIG. 1, computer software is typically used to allow a communication network, such as network 121, to store, retrieve and transmit the audio signals. This can be the same software currently in use to implement telephone communication method, such as CDMA, TDMA and GSM. For example, the software controls the flow of the hold and termination signals.

Audio signal S_{Audio} can include many different types of information, such as a voice message, music, news, advertisements or any other audible information. In some embodiments, user phone 122 allows its user to record a message, which is used as audio signal S_{Audio}. The recordation of the message can be facilitated with the use of many different types of electronic devices, such as a computer, music player and/or a microphone. In this way, the user has the ability to create, download and upload his or her own personalized data file.

The creation, downloading and uploading of the personalized data file can be facilitated with the software mentioned above. Alternatively, the user can upload messages to communication network 121 through an internet connection. Also, the user can purchase recordings, such as songs, for the purpose of having the option to use those purchased recordings as audio signal S_{Audio}.

The audio files can be prestored or they can be uploaded and stored by user phone 122 through communication link 125. A number of prestored audio files can exist and one or more of them can be selected by the user of phone 122. Advertisers can also pay to have their own audio file prestored with communication network 121, so that user 122a has the option of selecting it using phone 122.

In some embodiments, audio signal S_{Audio} is stored in an account corresponding to phones 122 or 123 that is accessible to communication network 121. In one particular embodiment, audio signal S_{Audio} is stored with base station 105. This account can have one or more data files stored with it, wherein each data file corresponds to a different audio signal. The audio signal transmitted to client phone 123 is selected from the data file (s). It should be noted that one audio file can be played or they can be played sequentially. The audio signal can be selected in many different ways, such as with a selection signal S_{Select}.

In one embodiment, user phone 122 provides selection signal S_{Select} to communication network 121 through communication link 125 and the data file is transferred to his or her account. The content of the selected data file is then transmitted to user phone 123 through communication link 126 when phone 123 is in its hold condition. The account of user phone 122 can be billed for this service and for access to the data file(s). In this way, the audio signal is selected in response to user phone 122.

In another embodiment, a third party account provides a selection signal that corresponds with the account of client phone 123. In some embodiments, the third party account is that of an advertising or marketing firm and is used by them to expose a number of mobile phone users to adverts when they are “holding”. A data file is selected based on information corresponding to the account of client phone 123. The content of the selected data file is then transmitted to user phone 123 as described above. The third party account can be billed for this service and for access to the data file(s). In this way, the audio signal is selected in response to client phone 123. The selection signal can correspond with the account of client phone 123 in many different ways, as will be discussed in more detail presently.

In this embodiment, audio signal S_{Audio} is determined in response to the parameter of user phone 122 and/or client phone 123. The parameter of phones 121 and 122 can be determined in many different ways, such as through their corresponding phone numbers and/or phone records. The parameter of user phone 122 and 123 can be used to determine information about their users. The user of phones 122 and 123 are generally the person to whom the phone belongs too, although it can be somebody else. For example, the phone can belong to a company and the user can be an employee of the company. In another example, the phone can belong to an adult and the user can be a relative of the adult.

FIG. 5 is a block diagram of a communication system 130, in accordance with the invention. In this embodiment, communication system 130 includes a user phone 139 which can establish a communication link with client phones 123 and 124 through base-station 105. It should be noted that one or more client phones can be included in system 130, but two are shown here for illustrative purposes.

User phone 139 has several options available when communicating with more than one client phone. In a first option, user phone 139 establishes a conference call with both client phones 123 and 124. In a second option, user phone 139 establishes an active condition with one of client phones 123 and 124 and a hold condition with the other one. In a third option, user phone 139 establishes a hold condition with both client phones 123 and 124.

User phone 139 selects which of client phones 123 and 124 is provided with the active and hold conditions. For example, in response to the user of phone 139 pressing a client selection keypad button 132, a multiport switch 142 allows base-station 105 to connect client phone 123 to phone 139. In this way, phone 123 is in its active condition and communication links 125 and 126 are established. Similarly, in response to the user of phone 139 pressing a client keypad button 133, a multiport switch 143 allows base-station 105 to connect client phone 124 to user phone 139. In this way, phone 124 is in its active condition and communication links 125 and 127 are established. Further, client phone 123 is moved from its active to hold condition by deactivating client selection keypad button 132 and client phone 124 is moved from its active to hold condition by deactivating client selection keypad button 133.

In this embodiment, the user of phone 139 has the option of providing client phones 123 and/or 124 with an audio signal in response to one or both of them being in a hold condition. In accordance with the invention, the audio signal is stored with user phone 139. In this particular embodiment, the audio signal is stored as an audio file in a register included with user phone 139. In this way, the audio file is stored internally with a phone instead of externally to it, as in FIG. 4.

In this embodiment, phone 139 includes registers 135, 136 and 137 which store audio files corresponding to audio signals S_{Audio1}, S_{Audio2} and S_{Audio3}, respectively. Here, audio signals S_{Audio1}, S_{Audio2} and S_{Audio3} correspond to different audio signals, although they can be the same audio signals in other examples. It should be noted that phone 139 generally includes one or more registers, but three are shown here for illustrative purposes.

In some situations, the user of phone 139 can record his or her own audio signal using an electronic device, such as a PC, I-Pod™, MP3 Player, or microphone, and store it using the register(s). The user can also allow phone 139 to utilize radio stations for his or her audio signal, such as many land lines do. The audio signals can be stored in many different formats, such as raw data or formatted data (MP3, for example). The registers can include many different types of memory, such as FLASH memory, and additional circuitry (not shown) is often included with phone 139 to control and process the flow of data between the registers and communication link 125.

Client phones 123 and 124 can be provided with the same or different audio signals. To select a particular audio signal, the user of phone 139 activates client message selection keypad button 134 and/or 138, then selects one of registers 135, 136 and 137. The selected register outputs its corresponding audio file through a corresponding routing switch 140 and 141. If client phone 123 is selected, the audio signal corresponding to that audio file flows through routing switch 140 and multiport switch 142 and through base-station 105 to client phone 123. In this way, the audio signal flows through communication links 125 and 126. If client phone 124 is selected, the audio signal corresponding to that audio file flows through routing switch 141 and multiport switch 143 and through base-station 105 to client phone 124. In this way, the audio signal flows through communication links 125 and 127.

The embodiments of the invention described herein are exemplary and numerous modifications, variations and rearrangements can be readily envisioned to achieve substantially equivalent results, all of which are intended to be embraced within the spirit and scope of the invention.

1. A system, comprising:
a communication network;
first and second mobile phones in communication with each other through the communication network; and
an audio file accessible to the communication network, the content of the audio file being played by the first mobile phone in response to it moving to a hold condition.

2. The system of claim 1, wherein the audio signal is stored externally to the first and second phones.

3. The system of claim 1, wherein the communication network includes a base-station which stores the audio file.

4. The system of claim 1, wherein the audio file is selected from a plurality of audio files accessible to the communication network.

5. The system of claim 4, wherein the audio file content played by the first mobile phone is selected in response to a parameter of the first or second mobile phones.

6. The system of claim 4, wherein the plurality of audio files are stored in an account accessible to the communication network.

7. The system of claim 6, wherein the audio file content played is selected in response to personal information of the account.

8. A method of providing an audio signal to a phone user, comprising:
establishing communication between first and second phones through a communication network; and
receiving the audio signal with the first phone in response to the first phone being in a hold condition, the audio signal being determined in response to a parameter of the first or second phones.

9. The method of claim 8, wherein the step of receiving the audio signal includes transmitting it from a base-station of the communication network.

10. The method of claim 8, wherein the step of receiving the audio signal includes selecting an audio file stored with a base-station of the communication network.

11. The method of claim 8, wherein the audio signal corresponds to an advertisement.

12. The method of claim 11, further including storing the audio file with a base-station of the communication network in response to a selection signal from the second phone.

13. The method of claim 8, further including establishing, through the communication network, communication between the first and second mobile phones and a third mobile phone, the first and third mobile phones receiving and outputting the same or different audio signals when they are in the hold condition.

14. A method, comprising:
determining which mobile phones in communication with a communication network have a hold condition, the communication network having access to one or more audio files; and
transmitting an audio signal to the mobile phones that have the hold condition, the audio signal corresponding to a selected one of the audio files.

15. The method of claim 14, wherein the step of transmitting the audio signal includes transmitting it from a base-station of the communication network.

16. The method of claim 14, wherein the audio signal is selected in response to a parameter of the mobile phone.

17. The method of claim 14, wherein the audio files are stored with a base-station of the communication network.

18. The method of claim 14, further including storing the audio file(s) with a base-station of the communication network.

19. The method of claim 14, further including terminating the transmission of the audio signal to the mobile phones that no longer have the hold condition.

20. The method of claim 14, further including playing the audio signal with the mobile phones that have the hold condition.
